(19) United States
(12) Patent Application Publication
(10) Pub. No.: US 2022/0009007 A1
(43) Pub. Date: Jan. 13, 2022

(54) QUICK TEE JOINT COMPONENT AND DRILLING JIG COMPONENT FOR DRILLING

(71) Applicant: Xiaoliang Zhang, Dalian (CN)

(72) Inventor: Xiaoliang Zhang, Dalian (CN)

(21) Appl. No.: 17/267,150

(22) PCT Filed: Aug. 7, 2019
(86) PCT No.: PCT/CN2019/099564

§ 371 Date: Feb. 9, 2021

(30) Foreign Application Priority Data
Aug. 13, 2018 (CN) 201810918356.1

(51) Int. Cl. B23B 47/28; F16L 41/12

(52) U.S. Cl. CPC B23B 47/281; F16L 41/12

(57) ABSTRACT

The invention discloses a quick tee joint component and a drilling jig component specially for drilling. For installation of a quick tee joint, a drilling jig for quick tee joint is firstly installed on a pipe where a branch pipe is to be added. A bushing of the drilling jig is in threaded connection with the drilling jig, to achieve convenient replacement, and is made of a high-hardness metal material. Under the limiting action of the bushing, the position of a reamer is ensured not to deviate during the reaming process, thereby ensuring the reaming quality. The requirement for different sizes of holes drilled by the drilling jig can be met by simply changing the size of the bushing of the drilling jig. Once reaming is done, fastening bolts are unscrewed so as to remove the drilling jig and a quick tee joint body is installed. A lengthening part of the quick tee joint body guarantees the installation position accuracy of the quick tee joint. In case of vertical installation of the quick tee joint, a notch in the lengthening part allows accumulated liquid to flow out to prevent the fluid from accumulating at the lowest point of the pipe for long time and affecting the working efficiency, thereby avoiding corrosion and extending the service life of the pipe.

### RELATED APPLICATIONS

This application is a national phase application of the International Application PCT/CN2019/099564 filed Aug. 7, 2019, which claims the benefit of the Chinese Patent Application CN201810918356.1 filed Aug. 13, 2018, each of which is incorporated herein by reference in its entirety.

### FIELD OF THE INVENTION

The present invention relates to a pipe connector, in particular to a quick tee joint component and a drilling jig component specially for drilling.

### BACKGROUND OF THE INVENTION

A quick tee joint is used for a horizontal or vertical connection point so as to connect a branch pipe to any position in a main pipe, without dismounting or replacing an original main pipeline, and has quick convenient installation and good sealing property. As shown in FIG. 1, an existing quick tee joint comprises a press ring and a downcomer pipe body buckled together vertically, and the press ring has a drilling jig reserved hole. During application, a reamer runs into the drilling jig reserved hole to drill a hole for later installation. In order to reserve a place for the reserved hole while ensuring strength, the press ring has to be wide enough and has its material strictly selected. In addition, press rings of various sizes have to be prepared so as to meet the requirement for different hole sizes, which increases cost.

### OBJECTS AND SUMMARY OF THE INVENTION

In order to overcome the shortcomings mentioned hereinabove, the present invention provides a quick tee joint component and a drilling jig component specially for drilling.

The quick tee joint component comprises a press ring and a quick tee joint body both buckled to fasten a main pipe inside; the middle of the quick tee joint body is provided with a downward branch pipe vertical to the main pipe; and two ends of the press ring and the quick tee joint body are fastened by bolts.

Further, the quick tee joint body outside the nozzle of the branch pipe is provided with a groove, and the groove is provided therein with a seal ring.

Further, the branch pipe is a straight pipe or bent pipe.

Further, the nozzle of the branch pipe has a lengthening part capable of being inserted into a hole in the main pipe to facilitate positioning and installing and ensure a reamer not to deviate during the reaming process, thereby ensuring the reaming quality.

Further, the lengthening part has a notch for guiding accumulated liquid to flow out and preventing the fluid from accumulating at the lowest point of the pipe for long time and affecting the working efficiency, thereby avoiding corrosion and extending the service life of the pipe.

Furthermore, a drilling jig component special for the quick tee joint component comprises the press ring, a drilling jig body is located below the press ring, the press ring and the drilling jig body are buckled to fasten a main pipe inside, two ends of the press ring and the drilling jig body are fastened by bolts, a threaded hole in the middle of the drilling jig body is connected with a bushing vertical to the main pipe, and the bushing is made of a high-hardness metal material.

For installation of a quick tee joint, a drilling jig for quick tee joint is firstly installed on a pipe where a branch pipe is to be added. A bushing of the drilling jig is in threaded connection with the drilling jig, to achieve convenient replacement, and is made of a high-hardness metal material. Under the limiting action of the bushing, the position of a reamer is ensured not to deviate during the reaming process, thereby ensuring the reaming quality. The requirement for different sizes of holes drilled by the drilling jig can be met by simply changing the size of the bushing of the drilling jig. Once reaming is done, fastening bolts are unscrewed so as to remove the drilling jig and a quick tee joint body is installed. A lengthening part of the quick tee joint body guarantees the installation position accuracy of the quick tee joint. In case of vertical installation of the quick tee joint, a notch in the lengthening part allows accumulated liquid to flow out to prevent the fluid from accumulating at the lowest point of the pipe for long time and affecting the working efficiency, thereby avoiding corrosion and extending the service life of the pipe.

### BRIEF DESCRIPTION OF FIGURES

FIG. 1 is a quick tee joint structure in prior arts;

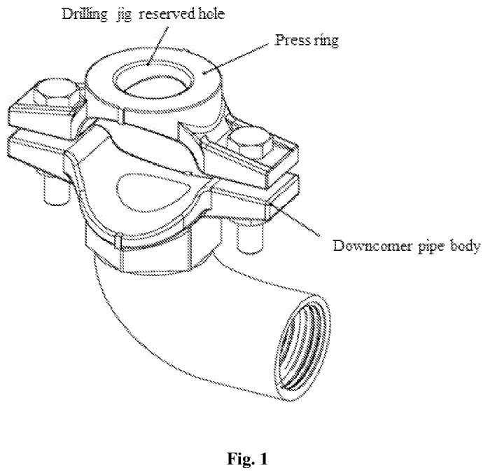

FIG. 2 is a cross-sectional view of a quick tee joint component;

FIG. 3 is a cross-sectional view of a special drilling jig component; and

FIG. 4 is a three-dimensional view of a special drilling jig component.

### DETAILED DESCRIPTION OF THE EMBODIMENTS

Hereinafter the technical solutions in embodiments of the present invention will be clearly and completely described in conjunction with the accompanying drawings in the embodiments of the invention. It is apparent that the embodiments described herein are only part rather than all of the embodiments of the invention. Based on the embodiments of the invention, all the other embodiments obtained by those skilled in the art without creative work fall within the protection scope of the invention.

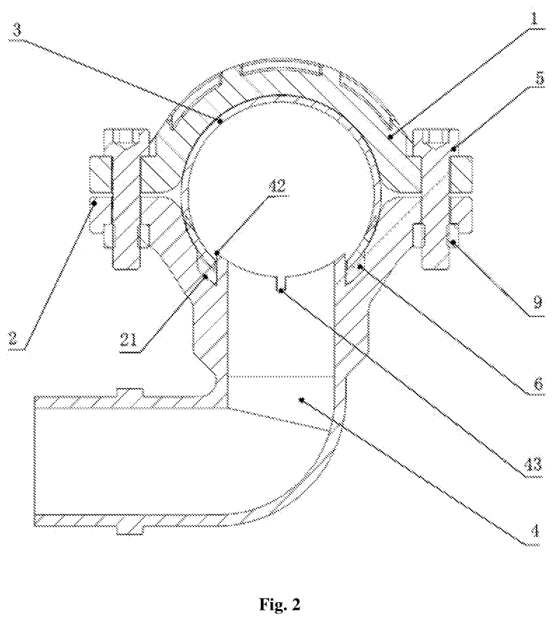

As shown in FIG. 2, a quick tee joint component comprises a press ring and a quick tee joint body both buckled to fasten a main pipe inside; the middle of the quick tee joint body is provided with a downward branch pipe vertical to the main pipe; and two ends of the press ring and the quick tee joint body are fastened by bolts. The quick tee joint body outside the nozzle of the branch pipe is provided with a groove 21, and the groove 21 is provided therein with a seal ring. The branch pipe is a bent pipe. The nozzle of the branch pipe has a lengthening part 42 capable of being inserted into a hole in the main pipe to facilitate positioning and installing and ensure a reamer not to deviate during the reaming process of the quick tee joint body, thereby ensuring the installation quality of the reamed quick tee joint. The lengthening part has a notch 43 for guiding accumulated liquid to flow out and preventing the fluid from accumulating at the lowest point of the pipe for long time and affecting the working efficiency, thereby avoiding corrosion and extending the service life of the pipe.

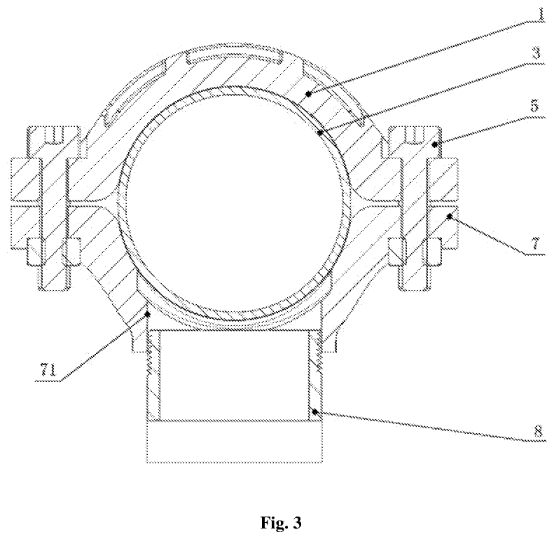

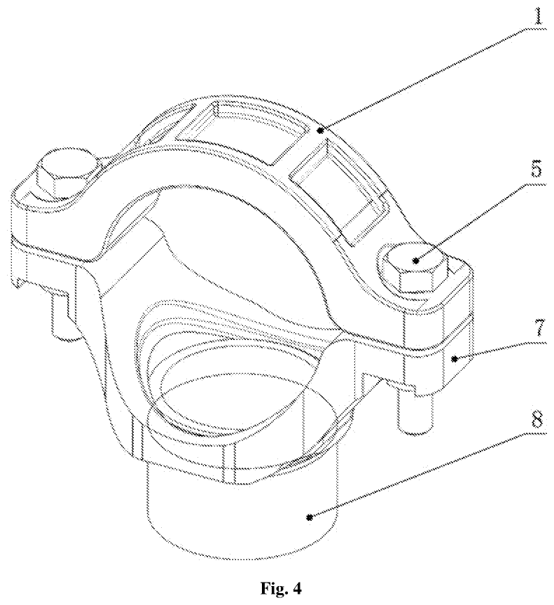

As shown in FIGS. 3-4, a drilling jig component special for quick tee joint component comprises the press ring, a drilling jig body is located below the press ring, the press ring and the drilling jig body are buckled to fasten a main pipe inside, two ends of the press ring and the drilling jig body are fastened by bolts, a threaded hole in the middle of the drilling jig body is connected with a bushing vertical to the main pipe, and the bushing is made of a high-hardness metal material.

During installation of a quick tee joint, a drilling jig for quick tee joint is firstly installed on a pipe where a branch pipe is to be added. A bushing of the drilling jig is in threaded connection with the drilling jig, to achieve convenient replacement, and is made of a high-hardness metal material. Under the limiting action of the bushing, the position of a reamer is ensured not to deviate during the reaming process, thereby ensuring the reaming quality. The requirement for different sizes of holes drilled by the drilling jig can be met by simply changing the size of the bushing of the drilling jig. Once reaming is done, fastening bolts are unscrewed so as to remove the drilling jig and a quick tee joint body is installed. A lengthening part of the quick tee joint body guarantees the installation position accuracy of the quick tee joint. In case of vertical installation of the quick tee joint, a notch in the lengthening part allows accumulated liquid to flow out to prevent the fluid from accumulating at the lowest point of the pipe for long time and affecting the working efficiency, thereby avoiding corrosion and extending the service life of the pipe.

What is claimed is:

1-7. (canceled)

8. A quick tee joint component, comprising a press ring and a quick tee joint body both buckled to fasten a main pipe inside, wherein:
the middle of the quick tee joint body is provided with a downward branch pipe vertical to the main pipe; and
two ends of the press ring and the quick tee joint body are fastened by bolts.

9. The quick tee joint component in claim 8, wherein:
the quick tee joint body outside the nozzle of the branch pipe is provided with a groove; and
the groove is provided therein with a seal ring.

10. The quick tee joint component in claim 9, wherein the branch pipe is a straight pipe or bent pipe.

11. The quick tee joint component in claim 10, wherein the nozzle of the branch pipe has a lengthening part capable of being inserted into a hole in the main pipe to facilitate positioning and installing.

12. The quick tee joint component in claim 11, wherein the lengthening part has a notch for guiding flow.

13. A drilling jig component for drilling a quick tee joint component, comprising a drilling jig body, wherein:
the quick tee joint component comprises a press ring and a quick tee joint body both buckled to fasten a main pipe inside;
the middle of the quick tee joint body is provided with a downward branch pipe vertical to the main pipe;
two ends of the press ring and the quick tee joint body are fastened by bolts;
the drilling jig body is located below the press ring;
the press ring and the drilling jig body are buckled to fasten a main pipe inside;
two ends of the press ring and the drilling jig body are fastened by bolts; and
a threaded hole in the middle of the drilling jig body is connected with a bushing vertical to the main pipe.

14. The drilling jig component in claim 13, wherein the bushing is made of a high-hardness metal material.

15. The drilling jig component in claim 14, wherein:
the quick tee joint body outside the nozzle of the branch pipe is provided with a groove; and
the groove is provided therein with a seal ring.

16. The drilling jig component in claim 15, wherein the branch pipe is a straight pipe or bent pipe.

17. The drilling jig component in claim 16, wherein the nozzle of the branch pipe has a lengthening part capable of being inserted into a hole in the main pipe to facilitate positioning and installing.

18. The drilling jig component in claim 17, wherein the lengthening part has a notch for guiding flow.
